(19) United States
(12) Patent Application Publication
(10) Pub. No.: US 2026/0019260 A1
(43) Pub. Date: Jan. 15, 2026

(54) Electronic processing device, avionics computer, communication infrastructure and associated processing method

(71) Applicant: THALES, Meudon (FR)

(72) Inventor: Stéphane MONNIER, MERIGNAC (FR)

(21) Appl. No.: 19/260,502

(22) Filed: Jul. 6, 2025

(30) Foreign Application Priority Data
Jul. 11, 2024 (FR) 2407601

(51) Int. Cl. H04L 9/32

(52) U.S. Cl. CPC H04L 9/321; H04L 2209/84

(57) ABSTRACT

An electronic processing device designed to be onboard an aircraft and including a first reception module that is configured to receive an encrypted message, a second reception module that is configured to receive an associated decrypted message, the decrypted message being calculated by means of a decryption algorithm applied to the encrypted message by a decryption device, external to the processing device, and wherein it further includes a verification module that is configured to verify the behavior of the decryption device by means of a comparison between the encrypted message and the associated decrypted message according to a set of comparison criteria.

### REFERENCE TO RELATED APPLICATIONS

This application is a U.S. non-provisional application claiming the benefit of French Patent Application No. 24 07601 filed on Jul. 11, 2024, the contents of which are incorporated herein by reference in their entirety.

### TECHNICAL FIELD OF THE INVENTION

This invention relates to an electronic processing device designed to be onboard an aircraft.

The invention also relates to an avionics computer designed to be onboard an aircraft, the computer including a flow-management device, a decryption device and such a processing device.

The invention also relates to a communication infrastructure including a ground computer intended for installation at ground level and such an avionics computer.

The invention also relates to a processing method implemented by such a processing device; as well as a non-transitory computer-readable medium including a computer program including software instructions which, when executed by a computer, implement such a processing method.

The invention relates to the field of communications in the context of ATN/IPS (Aeronautical Telecommunication Network using the Internet Protocol Suite) designating aeronautical telecommunication networks based on the Internet connection protocol.

### BACKGROUND OF THE INVENTION

In the context of ATN/IPS, computer security during communication is paramount to ensure the safety of aircraft in the event of a cyberattack or telecommunication system failure.

More specifically, the invention includes computer security during communication between ground equipment and certified equipment onboard an aircraft.

In the world of aeronautical telecommunications, it is common to have an aircraft communicate with ground equipment using an avionics system that is configured to allow such communication. Generally, the messages exchanged during these communications are encrypted, and the avionics system includes one or more decryption/encryption algorithms to decrypt encrypted messages received from the ground equipment or even to encrypt potential messages to the ground equipment.

Moreover, such an avionics system must be certified to meet aeronautical needs, such as with SAL (Security Assurance Level) certification or in accordance with DAL (Design Assurance Level) certification.

However, the list of decryption algorithm(s) necessary to decrypt encrypted messages received from ground equipment is likely to evolve, and therefore a new certification of such an avionics system is potentially necessary with each evolution of that list.

### SUMMARY OF THE INVENTION

The aim of the invention is then to propose an electronic processing device and an associated method, allowing to remedy this problem.

To this end, the invention aims at a processing device designed to be onboard an aircraft and including:
A first reception module configured to receive an encrypted message;
A second reception module configured to receive an associated decrypted message, the decrypted message being calculated by means of a decryption algorithm applied to the encrypted message by a decryption device, external to the processing device; and
The processing device further including a verification module configured to verify the behavior of the decryption device by means of a comparison between the encrypted message and the associated decrypted message according to a set of comparison criteria.

The processing device onboard the aircraft according to the invention then allows verifying the behavior of the decryption device, external to the processing device, which performed the decryption of the received encrypted message, i.e., to verify the integrity of the decryption device by means of regular monitoring of the decrypted messages, these being compared to each respective encrypted message.

Thus, the processing device is certified, but the decryption device is not certified, and a possible change of decryption algorithm does not then require new certification.

Moreover, the processing device also makes it possible, by means of such integrity verification, to quickly detect a potential cyberattack against the decryption device.

According to other advantageous aspects of the invention, the processing device includes one or more of the following features, which are taken individually or according to all technically feasible combinations:
The decryption algorithm is compliant with the Data Transport Layer Security (DTLS) protocol;
The set of comparison criteria includes the first comparison criterion depending on the size of the encrypted message and the size of the decrypted message;
The set of comparison criteria includes the second comparison criterion depending on the temporal instant of the receipt of the encrypted message and the temporal instant of the receipt of the decrypted message;
The second comparison criterion is that a gap between the temporal instant of the receipt of the encrypted message and the temporal instant of the receipt of the decrypted message is less than a predefined duration, e.g., 100 ms;
The verification module is configured to compare the encrypted message and the associated decrypted message according to the set of comparison criteria, in the absence of an implementation of the decryption algorithm within the processing device.
The invention also includes an avionics computer designed to be onboard an aircraft and including:
A decryption device that is configured to receive an encrypted message and calculate an associated decrypted message by means of a decryption algorithm;
A processing device that is configured to process the decrypted message; and
A flow-management device that is configured to receive a data flow and extract the encrypted message, then to transmit the encrypted message to both the processing device and the decryption device, the processing device being as defined above.

According to other advantageous aspects of the invention, the avionics computer includes one or more of the following features, which are taken individually or according to all of the technically feasible combinations:
The processing device is configured to command a restart of the decryption device if the comparison criteria are not met;
The processing device is configured to command the implementation of a new decryption device if the comparison criteria are not met again following the restart of the decryption device; and
The processing device is configured to receive, during the first exchange, a verification data from a ground computer through a secure communication channel and verify the establishment of such the first exchange by means of a state machine.

Moreover, the invention includes a communication infrastructure including:
An avionics computer designed to be onboard an aircraft and configured to receive and process a data flow; and
A ground computer intended for installation at ground level and configured to generate and transmit the data flow to the avionics computer, with the avionics computer being as defined above.

Moreover, the invention includes a processing method implemented by an electronic processing device and including the following steps:
Receipt of an encrypted message;
Receipt of an associated decrypted message, the decrypted message being calculated by means of a decryption algorithm applied to the encrypted message by a decryption device, external to the processing device; and
Verification of the behavior of the decryption device by means of a comparison between the encrypted message and the associated decrypted message according to a set of comparison criteria.

According to other advantageous aspects of the invention, the processing method includes the following step:
Before the reception step, an initial exchange of unencrypted data and including:
Generation of a private client key and a public client key by a ground computer;
Generation of a private server key and a public server key by the decryption device;
Transmission of a recognition message, from the ground computer toward the decryption device by means of a secure communication channel between the ground computer and the decryption device, the recognition message including at least random client signature data, a list of supported encryption algorithms, the public client key and a list of supported cryptography services;
Receipt of the recognition message by the decryption device;
Selection of an encryption algorithm and a cryptography service from the received lists;
Transmission of the second recognition message, from the decryption device, to the ground computer by means of the communication channel, the second recognition message including at least the selected encryption algorithm, the public server key and the selected cryptography service;
Calculation of the first verification data by the decryption device from the public client key and the private server key;
Calculation of the second verification data by the ground computer from the public server key and the private client key; and
Establishment of an encrypted communication between the ground computer and the avionics computer, the communication being authorized only if the first verification data is equivalent to the second verification data.

Finally, the invention also pertains to a non-transitory computer-readable medium including a computer program including software instructions that, when executed by a computer, implement the above-described processing.

### BRIEF DESCRIPTION OF THE DRAWINGS

The invention will be more understandable with help from the following description, which is given solely by way of a non-limiting example and made with reference to the drawings wherein:

FIG. 1 is a schematic representation of a communication infrastructure, according to the invention, the communication infrastructure including a ground computer intended for installation at ground level and an avionics computer designed to be onboard an aircraft, the avionics computer including a flow-management device, a decryption device and a processing device according to the invention; and

FIG. 2 is a flowchart of a processing method according to the invention, the method being implemented by the processing device of FIG. 1.

### DETAILED DESCRIPTION OF THE INVENTION

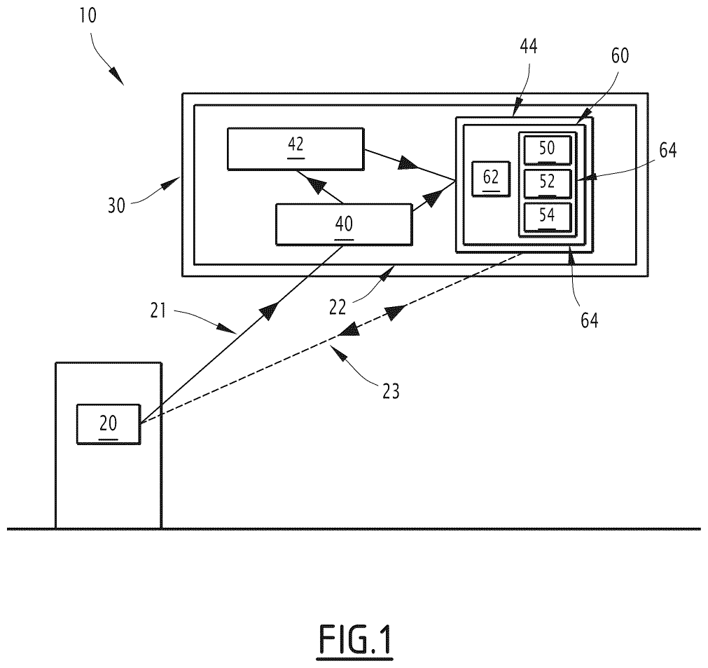

In FIG. 1, a communication infrastructure 10 includes a ground computer 20 intended for installation at ground level and an avionics computer 22 designed to be onboard an aircraft 30.

For example, the ground computer 20 is configured to generate and transmit a data flow 21 to the avionics computer 22 by means of a data link. The data flow 21 includes at least one encrypted message. Typically, the data flow 21 also includes MAC, IP, UDP addresses, a source and a destination. The data link is known in itself and is typically a radio link.

The avionics computer 22 is configured to receive and process the data flow 21.

The avionics computer 22 includes an electronic flow-management device 40, an electronic decryption device 42 and an electronic processing device 44.

Typically, the flow-management device 40, the decryption device 42 and the processing device 44 are interconnected.

For example, the flow-management device 40, the decryption device 42 and the processing device 44 run on the same processor.

Alternatively, only the decryption device 42 and the processing device 44 run on the same processor.

As another alternative, the flow-management device 40, the decryption device 42 and the processing device 44 each run on a respective distinct processor. According to this variant, the flow-management device 40, the decryption device 42 and the processing device 44 then run overall on three distinct processors.

The flow-management device 40 is configured to receive the data flow 21. Additionally, the flow-management device 40 is configured to process only legitimate data flows. For example, legitimate data flows contain coherent MAC, IP, UDP addresses, a source and a destination.

Moreover, the flow-management device 40 is configured to extract the encrypted message from the data flow 21.

The decryption device 42, also referred to as the decryption device, is configured to receive the encrypted message and calculate an associated decrypted message by means of a decryption algorithm.

Advantageously, the decryption device 42 requires no avionics certification.

For example, the decryption algorithm is compliant with a communication protocol, such as the DTLS protocol (Data Transport Layer Security).

Alternatively, the communication protocol to which the decryption algorithm is compliant is chosen from the group consisting of: the TCP protocol (Transport Control Protocol), the IPV6 protocol, the Packet Firewall protocol, the ICMP protocol (Internet Control Message Protocol) and the TLS protocol (Transport Layer Security).

The decryption algorithm is for example chosen from the group consisting of: a SHA algorithm (Secure Hash Algorithm), an AES algorithm (Advanced Encryption Standard), a CCM algorithm (Counter mode with Cipher block chaining Message) and a GCM (Galois Counter Mode) algorithm.

When the decryption algorithm is of the SHA type, it uses, for example, a cryptography service chosen from the group of cryptography services including: TLS_AES_128_GCM_SHA256, TLS_AES_128_CCM_SHA256, TLS_AES_256_GCM_SHA384.

Optionally, the decryption algorithm is coded in Linux, and the decryption device 42 is configured to include only a predefined list of libraries necessary for the operation of the decryption algorithm.

The processing device 44 includes the first reception module 50, the second reception module 52 and a verification module 54.

Unlike the decryption device 42, the processing device 44 is advantageously certified, such as with SAL certification or in accordance with DAL certification.

In the example of FIG. 1, the processing device 44 includes an information processing unit 60 formed, for example, of a processor 62 and a memory 64 associated with the processor 62.

Additionally, in the example of FIG. 1, the first reception module 50, the second reception module 52 and the verification module 54 are each implemented in the form of software or a software brick, being executable by the processor 62. The memory 64 of the processing device 44 is then able to store the first reception software, the second reception software and the verification software. The processor 62 is then able to execute each of the software among the first reception software, the second reception software and the verification software.

In an unrepresented variant, the first reception module 50, the second reception module 52 and the verification module 54 are each implemented in the form of a programmable logic component, such as an FPGA (Field Programmable Gate Array) or even in the form of a dedicated integrated circuit, such as an ASIC (Application Specific Integrated Circuit).

When the processing device 44 is implemented in the form of one or more software, i.e., in the form of a computer program, it is also able to be recorded on a medium, not represented, readable by a computer. The computer-readable medium is, for example, a medium able to memorize electronic instructions and to be coupled to a bus of a computer system. For example, the readable medium is an optical disk, a magneto-optical disk, a ROM memory, a RAM memory, any type of nonvolatile memory (for example EPROM, EEPROM, FLASH, NVRAM), a magnetic card or an optical card. On the readable medium is then memorized a computer program including software instructions.

For example, the processing device 44 is in an IMA (Integrated Module Avionics). An IMA is an avionics network system including a plurality of computer modules capable of supporting many applications of different levels of criticality.

The first reception module 50 is configured to receive the encrypted message from the flow-management device 40.

The second reception module 52 is configured to receive the decrypted message from the decryption device 42.

The verification module 54 is configured to verify the behavior of the decryption device 42 by means of a comparison between the encrypted message and the associated decrypted message according to a set of comparison criteria.

The set of comparison criteria includes the first comparison criterion depending on the size of the encrypted message and the size of the decrypted message.

For example, if the size of the encrypted message is of a size equal to that of the decrypted message, the processing device 44 validates the behavior of the decryption device 42 as normal, and the decryption device 42 is considered compliant, i.e., integral. On the contrary, if the size of the encrypted message is different from the size of the decrypted message, the processing device 44 will not validate the behavior of the decryption device 42, and the decryption device 42 is considered noncompliant, i.e., non-integral. Particularly, a size discrepancy between the encrypted message and the decrypted message may indicate that the decryption device 42 is defective or is subjected to a cyberattack.

Additionally, the set of comparison criteria includes the second comparison criterion depending on the temporal instant of the receipt of the encrypted message and the temporal instant of the receipt of the decrypted message by the processing device 44.

For example, if the decryption device 42 is defective or is subjected to a cyberattack, the processing of messages will typically slow down, causing an increased temporal gap between the instant of reception by the processing device 44 of the encrypted message and that of the decrypted message.

For example, the second comparison criterion is that a gap between the temporal instant of the receipt of the encrypted message and the temporal instant of the receipt of the decrypted message is less than a predefined duration, e.g., 100 ms. Such a temporal-gap value is slightly higher than the normal calculation time of the decryption device 42.

Advantageously, the verification module 54 is configured to compare the encrypted message and the associated decrypted message according to the set of comparison criteria, in the absence of an implementation of the decryption algorithm within the processing device 44.

Optionally, the processing device 44 is configured to command a restart of the decryption device 42 if the comparison criteria are not met. A person who is skilled in the art will recognize that the ability of the processing device 44 to restart such a decryption device 42 without impacting the other partitions of the same system is a property of the OS (Operating System) of the IMA.

Additionally, the processing device 44 is configured to command the implementation of a new decryption device 42 if the comparison criteria are not met again after the decryption device 42 is restarted.

Additionally, the processing device 44 is configured to verify the integrity of the first data exchange between the decryption device 42 and the ground computer 20 by means of a state machine, the first data exchange being conducted by means of a secure communication channel 23.

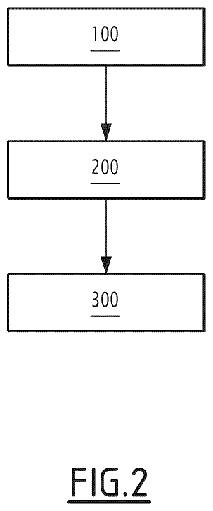

The operation of the avionics computer 22 according to the invention, particularly with respect to the electronic processing device 44, is explained with the help of FIG. 2 representing a flowchart of the processing method according to the invention.

Initially, the first data exchange is not encrypted and is divided into a plurality of successive actions.

During the first generation action, the ground computer 20 generates a private client key and a public client key. In parallel, the decryption device 42 generates a private server key and a public server key. Typically, the generated private keys are coded on 32 bytes and therefore have values between 0 and 2256-1. [NUMBER COPIED FROM FRENCH] Advantageously, such key sizes improve security in the event of a cyberattack, such as a brute force attack.

During the second recognition action, the ground computer 20 transmits a recognition message toward the decryption device 42 by means of the secure communication channel 23. The recognition message includes at least a random client signature data, a list of supported encryption algorithms, the public client key and a list of supported cryptography services. Optionally, the list of encryption algorithms and the list of cryptography services are arranged in order of preference.

When the decryption device 42 receives the recognition message, the decryption device 42 in turn transmits the second recognition message to the ground computer 20 by means of the secure communication channel 23. The second recognition message includes at least a selected encryption algorithm from the list received from the ground computer 20, the public server key and a selected cryptography service from the list received from the ground computer 20. If the received lists are arranged in order of preference, the decryption device 42 selects the first encryption algorithm and the first cryptography service that it is capable of handling in the lists.

Then, the decryption device 42 calculates the first verification data from the public client key and the private server key. For example, the verification data is the result of applying the curve25519( ) algorithm to the public client key and the private server key.

In parallel, the ground computer 20 calculates the second verification data by applying the curve25519( ) algorithm to the public server key and the private client key. Advantageously, the calculations performed by the computer 20 and the decryption device 42 have the same result thanks to the properties of the elliptic curve multiplication of the curve25519( ) algorithm.

The first verification data transmitted by the decryption device 42, and respectively the second verification data transmitted by the ground computer 20, during such exchanges, make it possible to verify that the data communication is authorized between the two devices.

During such exchanges, a communication received by the decryption device 42 or respectively by the ground computer 20 is interrupted (with the exclusion of the corresponding verification data).

Moreover, to authorize the reception of encrypted messages from the ground computer 20, the decryption device 42 first verifies that the calculated first verification data is equivalent to the received second verification data; and conversely, to authorize the reception of encrypted messages from the decryption device 42, the ground computer 20 first verifies that the calculated second verification data is equivalent to the received first verification data.

Subsequent to the completion of those actions, communications between the ground computer 20 and the avionics computer 22 are encrypted. The encryption algorithm and the cryptography service used during the communications are known to the ground computer 20 and the decryption device 42, and each of the computers is capable of reading encrypted data received by the other computer or transmitting encrypted data to the other computer.

During each communication the ground computer 20 and the decryption device provide the corresponding verification data without which the communication is interrupted.

Moreover, the state machine verifies the integrity of the random client signature data and if one of the previous actions is not properly implemented. If the integrity is not verified, the avionics computer 22 will refuse communication.

During step 100, the electronic processing device 44 receives, by means of its first reception module 50, a respective encrypted message from the flow-management device 40.

Advantageously, the electronic processing device 44 receives the encrypted message once the first exchange has been established and the verification data has been validated.

Subsequent to the first reception step 100, the processing device 44 receives, during a next step 200 and by means of its second reception module 52, a respective decrypted message from the decryption device 42.

A person who is skilled in the art will understand that the calculation time, i.e., implementation, of the decryption device 42 implies a gap between the temporal instant of the receipt of the encrypted message and the temporal instant of the receipt of the decrypted message by the processing device 44, i.e., between the temporal instant associated with the first reception step 100 and the temporal instant associated with the second reception step 200.

For example, the decrypted message corresponds to the useful part of data extracted from the data flow 21.

The decrypted message is calculated from the encrypted message by means of the application of the decryption algorithm to the encrypted message.

The decryption algorithm is applied by the decryption device 42, external to the processing device 44. For example, the decryption algorithm is applied by the decryption device 42 of the avionics computer 22.

The processing device 44 then verifies, during a next step 300 and by means of its verification module 54, the behavior of the decryption device 42.

This behavior verification then aims to verify the integrity of the decryption device 42, particularly the fact that it has not been subjected to an attack.

The verification is implemented by means of a comparison between the encrypted message and the associated decrypted message according to the set of comparison criteria.

Advantageously, if the comparison criteria are not met, the processing device 44 commands the restart of the decryption device 42.

Optionally, if the comparison criteria are not met again after the decryption device 42 is restarted, the processing device 44 will command the implementation of a new decryption device 42.

Thus, it is understood that the electronic processing device 44 according to the invention allows verifying the integrity and availability of the decryption device 42 which is external to the processing device 44 and then distinct from the processing device 44. The decryption device 42 is for example in the form of a COTS software onboard the aircraft 30.

Particularly, such an invention allows real-time monitoring of the integrity of the decryption device 42 as it executes a COTS software in the specific context of ATN/IPS.

Moreover, the invention makes it possible to quickly detect a potential cyberattack against the decryption device 42.

Finally, the capabilities of the processing device 44 to restart the decryption device 42 and to implement a new decryption device in the event of a detected problem ensure the availability of the decryption device 42, for example in the form of COTS software in the context of ATN/IPS.

1. An processor onboard an aircraft and comprising:
a first receiver receiving an encrypted message;
a second receiver receiving an associated decrypted message, the decrypted message being calculated by means of a decryption algorithm applied to the encrypted message by a decoder, external to the processing device; and
a verifier verifying behavior of the decoder by means of a comparison between the encrypted message and the associated decrypted message according to a set of comparison criteria.

2. The processor according to claim 1, wherein the decryption algorithm is compliant with the Data Transport Layer Security (DTLS) protocol.

3. The processor according to claim 1, wherein the set of comparison criteria includes a comparison criterion depending on the size of the encrypted message and the size of the decrypted message.

4. The processor according to claim 1, wherein the set of comparison criteria includes a comparison criterion depending on the temporal instant of the receipt of the encrypted message and the temporal instant of the receipt of the decrypted message.

5. The processor according to claim 4, wherein the comparison criterion is that a gap between the temporal instant of the receipt of the encrypted message and the temporal instant of the receipt of the decrypted message is less than a predefined duration.

6. The processor according to according to claim 1, wherein said verifier compares the encrypted message and the associated decrypted message according to the set of comparison criteria, in the absence of an implementation of the decryption algorithm within the processing device.

7. An avionics computer onboard an aircraft and comprising:
a decoder receiving an encrypted message and calculating a corresponding decrypted message by means of a decryption algorithm;
a processor according to claim 1, processing the decrypted message; and
a flow-manager receiving a data flow and extracting the encrypted message, then transmitting the encrypted message to both said decoder and said processor.

8. The avionics computer according to claim 7, wherein said processor commands a restart of said decoder when the comparison criteria are not met.

9. The avionics computer according to claim 8, wherein said processor commands implementation of a new decoder if the comparison criteria are not met again following the restart of said decoder.

10. The avionics computer according to claim 7, wherein said processor receives, during a first exchange, verification data from a ground computer through a secure communication channel and verifies establishment of the first exchange by means of a state machine.

11. A communication infrastructure comprising:
an avionics computer according to claim 7 onboard an aircraft receiving and processing a data flow; and
a ground computer installed at ground level and generating and transmitting the data flow to said avionics computer.

12. A processing method comprising:
receiving an encrypted message;
further receiving an corresponding decrypted message, the decrypted message being calculated by means of a decryption algorithm applied to the encrypted message by a decoder, external to the processing device; and
verifying behavior of the decoder by comparing the encrypted message with the associated decrypted message according to a set of comparison criteria.

13. The processing method according to claim 12, further comprising, before said receiving and before said further receiving, an initial exchange of unencrypted data comprising:
generating a private client key and a public client key by a ground computer;
generating a private server key and a public server key by the decoder;
transmitting a recognition message, from the ground computer toward the decoder via a secure communication channel between the ground computer and the decoder, the recognition message comprising random client signature data, a list of supported encryption algorithms, the public client key and a list of supported cryptography services;
receiving the recognition message by the decoder;
selecting an encryption algorithm and a cryptography service from the received lists;
transmitting the second recognition message, from the decoder, to the ground computer via the communication channel, the second recognition message comprising the selected encryption algorithm, the public server key and the selected cryptography service;
calculating first verification data by the decoder from the public client key and the private server key;
calculating second verification data by the ground computer from the public server key and the private client key; and
establishing encrypted communication between the ground computer and the avionics computer, communication being authorized only when the first verification data is equivalent to the second verification data.

14. A non-transitory computer-readable medium comprising a computer program including software instructions which, when executed by a computer, cause the computer to implement a processing method according to claim 12.
